(19) United States
(12) Patent Application Publication
(10) Pub. No.: US 2024/0182105 A1
(43) Pub. Date: Jun. 6, 2024

(54) APPARATUS FOR USE IN TURNING STEERABLE VEHICLE WHEELS

(71) Applicant: ZF Active Safety and Electronics US LLC, Livonia, MI (US)

(72) Inventors: Himadri Kumar Shastry, Washington, MI (US); Ramesh Chirla, Washington, MI (US); Michael Dawson, Washington, MI (US); Olivier Pugliese, Lebanon, IN (US); Ryan Noerenberg, Washington, MI (US)

(21) Appl. No.: 18/075,465

(22) Filed: Dec. 6, 2022

(51) Int. Cl. B62D 5/04

(52) U.S. Cl. CPC B62D 5/0448; B62D 5/0424; B62D 5/0463

(57) ABSTRACT

A steer-by wire apparatus for use in turning steerable vehicle wheels includes a steering member which is axially movable relative to the vehicle to effect turning movement of the steerable vehicle wheels. A ball nut assembly is connected with an externally threaded portion of the steering member. The steering member moves axially in response to rotation of the ball nut assembly relative to the steering member. A first motor connected with the ball nut assembly is operable to effect rotation of the ball nut assembly relative to the steering member. A pinion is in meshing engagement with the steering member. The steering member moves axially in response to rotation of the pinion. A second motor connected with the pinion is operable to effect rotation of the pinion relative to the steering member.

### TECHNICAL FIELD

The present invention relates to an apparatus for use in turning steerable vehicle wheels and, more specifically, to a steer-by-wire apparatus for use in turning steerable vehicle wheels.

### BACKGROUND

A known vehicle steering apparatus includes a steering member which is axially movable to effect turning movement of steerable vehicle wheels. A ball nut assembly is connected with an externally threaded portion of the steering member. A motor is connected with the ball nut assembly. The motor is operable to effect rotation of the ball nut assembly relative to the steering member.

### SUMMARY

The present invention relates to a steer-by wire apparatus for use in turning steerable vehicle wheels having a steering member which is axially movable relative to the vehicle to effect turning movement of the steerable vehicle wheels. A ball nut assembly is connected with an externally threaded portion of the steering member. The steering member moves axially in response to rotation of the ball nut assembly relative to the steering member. A first motor connected with the ball nut assembly is operable to effect rotation of the ball nut assembly relative to the steering member. A pinion is in meshing engagement with the steering member. The steering member moves axially in response to rotation of the pinion. A second motor connected with the pinion is operable to effect rotation of the pinion relative to the steering member.

In accordance with one of the features of the present invention, a gear is connected with the ball nut assembly and rotatable with the ball nut assembly relative to the steering member. The first motor is operable to effect rotation of the gear and the ball nut assembly relative to the steering member.

In accordance with another feature of the present invention, an idler gear is in meshing engagement with the gear connected with the ball nut assembly. The first motor is operable to effect rotation of the idler gear to effect rotation of the gear and the ball nut assembly relative to the steering member.

In accordance with another feature of the present invention, a worm shaft is connected to an output shaft of the second motor. The worm shaft is in meshing engagement with a worm wheel connected to the pinion. The worm shaft may have a press fit connection with the pinion.

In accordance with another feature of the present invention, a drive pulley is connected to an output shaft of the first motor and a belt is connected to the drive pulley and the ball nut assembly. The first motor is operable to effect rotation of the drive pulley. The belt transmits force from the drive pulley to ball nut assembly to rotate the ball nut assembly relative to the steering member.

In accordance with another feature of the present invention, a planetary gear stage connects the second motor to the pinion. The planetary gear stage may have a press fit connection with the pinion.

In accordance with another feature of the present invention, an electronic control unit (ECU) controls the first and second motors. At least one motor sensor detects whether at least one of the first and second motors is operating correctly. The ECU adjusts operation of one of the first and second motors if the other of the first and second motors is detected by the at least one motor sensor to not be operating correctly.

In accordance with another feature of the present invention, the first and second motors provide redundancy for each other.

### BRIEF DESCRIPTION OF THE DRAWINGS

The foregoing and other features of the present invention will become more apparent to those skilled in the art to which the present invention relates upon reading the following description with reference to the accompanying drawings, in which:

FIG. 1 is a schematic pictorial view of a first example of an apparatus for use in turning steerable vehicle wheels constructed in accordance with the present invention;

FIG. 2 is a schematic pictorial view of a portion of the apparatus of FIG. 1 with portions removed to show a gearing for rotating a pinion;

FIG. 3 is a schematic sectional view of a portion of the apparatus of FIG. 1;

FIG. 4 is a schematic pictorial view of a portion of the apparatus of FIG. 1 with portions removed to show a gearing driving a ball nut assembly;

FIG. 5 is a schematic pictorial view of a second example of an apparatus for use in turning steerable vehicle wheels constructed in accordance with the present invention;

FIG. 6 is a schematic pictorial view of a portion of the apparatus of FIG. 5 with portions removed to show a gearing driving a ball nut assembly;

FIG. 7 is a schematic pictorial view of a third example of an apparatus for use in turning steerable vehicle wheels constructed in accordance with the present invention;

FIG. 8 is schematic sectional view of a portion of the apparatus of FIG. 7;

FIG. 9 is a schematic pictorial view of a portion of the apparatus of FIG. 7 showing a planetary gear stage; and

FIG. 10 is a schematic pictorial view of a fourth example of an apparatus for use in turning steerable vehicle wheels constructed in accordance with the present invention.

### DETAILED DESCRIPTION

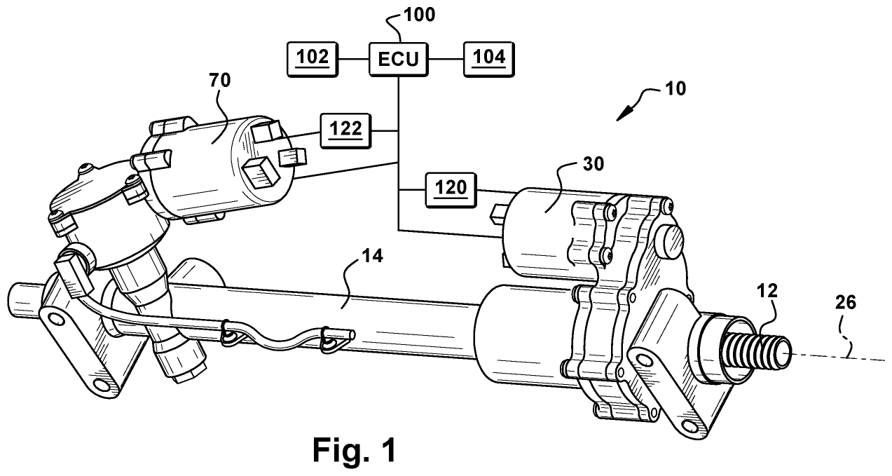

A first example of an apparatus 10 for turning steerable vehicle wheels constructed in accordance with the present invention is illustrated in FIG. 1. The apparatus 10 includes a steering member 12 which is connected to steerable vehicle wheels, as known in the art. A housing 14 supports the steering member 12 for axial or linear movement relative to the housing to turn the steerable vehicle wheels.

A ball nut assembly 20 (FIG. 4) extends around an externally threaded portion 22 of the steering member 12. The ball nut assembly 20 is supported in the housing 14 for rotation relative to the housing and the steering member 12 about a longitudinally extending central axis 26 of the of the steering member. Rotation of the ball nut assembly 20 relative to the steering member 12 is effective to move the steering member axially relative to the housing 14. The housing 14 encloses the ball nut assembly 20 along with at least a portion of the steering member 12.

A first reversible electric motor 30 is operable to rotate the ball nut assembly 20 relative to the steering member 12 and the housing 14. The first electric motor 30 has an output shaft 32 with a helical drive gear 34. The helical drive gear 34 may be formed on the output shaft 32 or connected to the output shaft 32. The helical drive gear 34 and output shaft 32 are supported in the housing 14 for rotation about a longitudinal axis 40 extending generally parallel to the axis 26 of the steering member 12.

The helical drive gear 34 meshes with an idler gear 46 to transmit torque from the first motor 30 to the idler gear. The idler gear 46 is supported in the housing 14 for rotation about an axis 50. The axis 50 of the idler gear 46 extends generally parallel to the axes 26 and 40 of the steering member 12 and the helical drive gear 34.

The idler gear 46 meshes with a driven gear 60 on the ball nut assembly 20 to transmit torque from the idler gear to the driven gear. The driven gear 60 is fixedly connected to the ball nut assembly 20 by a retaining member 64. The retaining member 64 may be an annular member that clamps the driven gear 60 to the ball nut assembly 20. It is contemplated that the retaining member 64 may threadably engage an axial end portion of the ball nut assembly 20. The idler gear 46 transmits force to the driven gear 60 from the first motor 30 to rotate the ball nut assembly 20 about the central axis 26 of the steering member 12 during operation of the first motor. Therefore, the steering member 12 moves axially relative to the housing 14 to turn the steerable vehicle wheels upon actuation of the first motor 30.

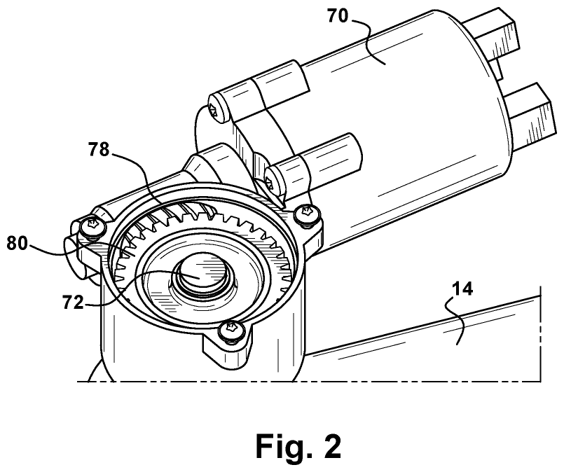

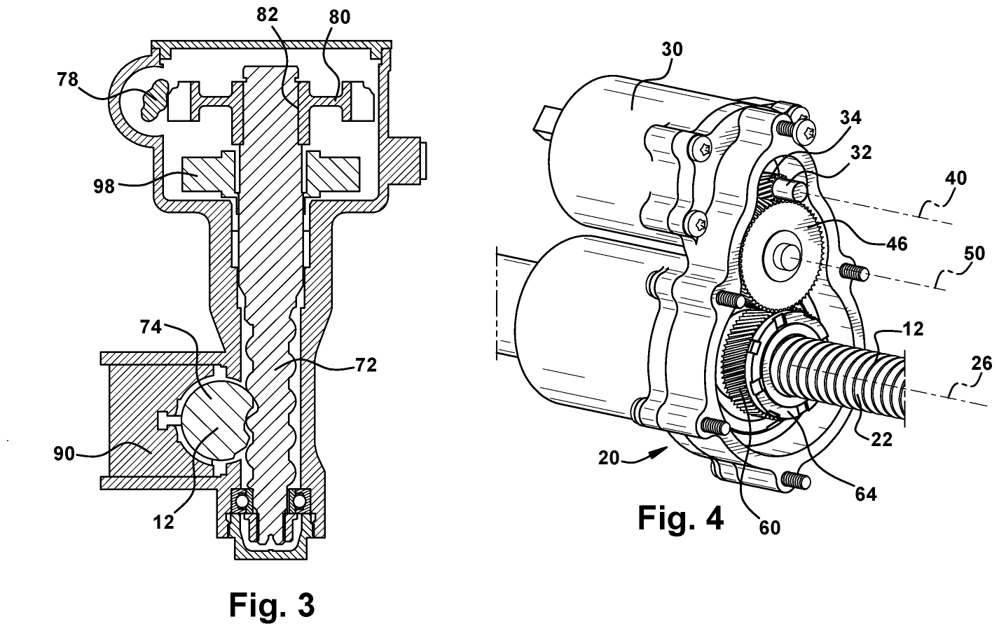

A second reversible electric motor 70 (FIGS. 2-3) is operable to rotate a pinion 72 in meshing engagement with a rack portion 74 of the steering member 12. Rotation of the pinion 72 relative to the housing 14 is effective to move the steering member 12 axially relative to the housing 14. The second electric motor 70 may rotate a worm shaft 78. The worm shaft 78 may be connected to an output shaft of the motor 70 or formed on the output shaft of the motor.

The worm shaft 78 is in meshing engagement with a worm wheel 80. The worm wheel 80 is connected with the pinion 72. The worm wheel 80 may have an opening 82 through which the pinion 72 extends. The pinion 72 may have a press fit connection with the worm wheel 80. Although the worm wheel 80 is described as having an opening 82 through with the pinion extends, it is contemplated that the worm wheel may have an output member that is press fit into an opening in the pinion. Also, it is contemplated that the worm wheel 80 may be connected to the pinion 72 in any desired manner. The worm wheel 80 and pinion 72 rotate in response to rotation of the electric motor 70. Thus, the steering member 12 moves axially relative to the housing 14 to turn the steerable vehicle wheels upon actuation of the second motor 70.

A pressure piece 90 (FIG. 3) may press the rack portion 74 of the steering member 12 toward the pinion 72. A spring element may apply a force to the pressure piece 90 to urge the pressure piece toward the steering member 12 and maintain engagement between the pinion 72 and the steering member. The toothed engagement between the pinion 72 and the rack portion 74 of the steering member 12 is maintained by the pressure piece 90.

A sensor wheel 98 may be connected to the pinion 72. The sensor wheel 98 may rotate with the pinion 72 relative to the housing 14. A sensor may detect the rotational position of the sensor wheel 98 relative to the housing 14 to determine the position of the steering member 12 relative to the housing.

The apparatus 10 (FIG. 1) may be a steer-by-wire apparatus that has no mechanical connection to a steering input member, such as a steering wheel. An electronic control unit (ECU) 100 may control the first and second motors 30, 70 to turn the steerable vehicle wheels. The ECU 100 affects operation of the first and second motors 30, 70 to axially move the steering member 12 relative to the housing 14 to steer the vehicle wheels. The ECU 100 may receive an input signal indicative of a desired path of travel for the vehicle. The ECU 100 may analyze the desired path of travel and operate the first and second motors 30, 70 to axially move the steering member 12 relative to the housing 14 to turn the vehicle wheels a predetermined amount and cause the vehicle to travel along the desired path. The ECU 100 may operate the first motor 30, the second motor 70 or both motors depending on the force necessary to move the steering member 12 the predetermined amount relative to the housing 14.

The apparatus 10 may include vehicle condition sensors 102, 104 for controlling the first and second motors 30, 70 based on sensed vehicle conditions. The vehicle condition sensors 102, 104 may include a torque sensor 102 and a position sensor 104 electrically connected to the ECU 100. The torque sensor 102 may sense torque applied to a steering wheel and generate a signal indicative of the torque. The position sensor 104 may sense the rotational position of the steering wheel and generate an electrical signal indicative of the steering wheel position. The electrical signals from the torque sensor 102 and the position sensor 104 are sent to the ECU 100. The ECU 100 analyzes the output of the sensors 102, 104 and effects operation of the first and second motors 30, 70 as a function of the output of the sensors.

In addition, the ECU 100 may have inputs which vary as a function of sensed lateral acceleration of the vehicle or other vehicle operating conditions. The ECU 100 receives the signals generated by the sensors and actuates the first and second motors 30, 70 in order to apply an axial force to the steering member 12 to turn the steerable vehicle wheels.

The sensor that senses the rotational position of the sensor wheel 98 connected to the pinion 72 may be electrically connected to the ECU 100. The electrical signals from the sensor are sent to the ECU 100. The ECU 100 analyzes the output of the sensor to determine if the steering member 12 has axially moved the predetermined amount.

The apparatus 10 may also include motor sensors 120, 122 that detect whether the first and second motors 30, 70 are operating correctly. The motor sensors 120, 122 may be electrically connected to the ECU 100. The ECU 100 may analyze the output of the motor sensors 120, 122 to determine if the first and second motors 30, 70 are operating correctly. If the ECU 100 determines that one of the first and second motors 30, 70 is not operating correctly, the ECU 100 may adjust the operation of the other motor to compensate for the motor not operating correctly. Therefore, the first and second motors 30, 70 may provide redundancy for each other.

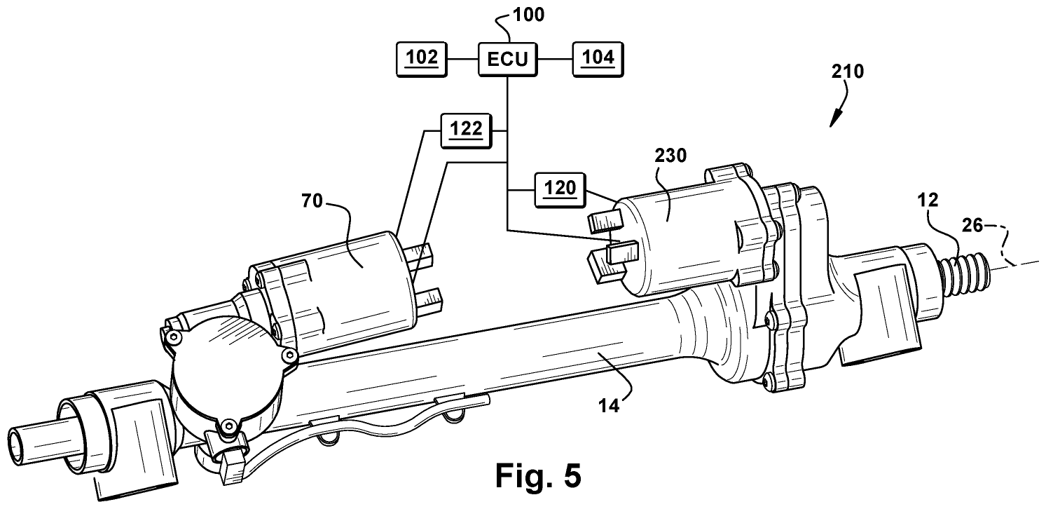

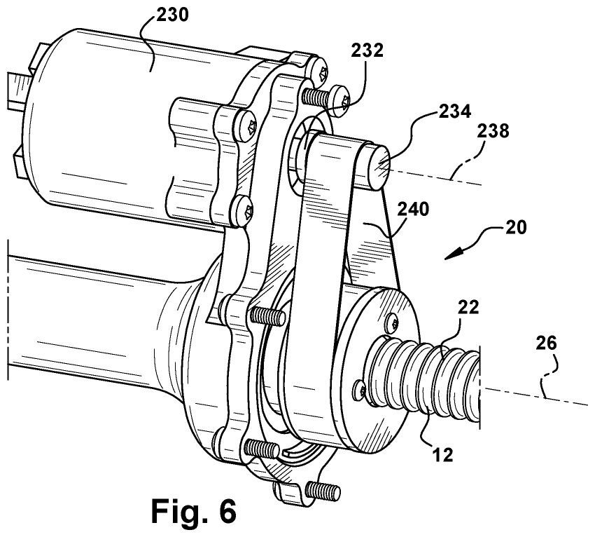

A second example of an apparatus 210 for turning steerable vehicle wheels constructed in accordance with the present invention is illustrated in FIGS. 5-6. The apparatus 210 of FIGS. 5-6 is generally similar to the apparatus 10 of FIGS. 1-4 and, therefore, only the differences will be described in detail.

A first reversible electric motor 230 (FIG. 6) is operable to rotate the ball nut assembly 20 relative to the steering member 12 and the housing 14. The first electric motor 230 has an output shaft 232 connected to a drive pulley 234. The drive pulley 234 and the output shaft 232 are supported in the housing 14 for rotation about a longitudinal axis 238 extending generally parallel to the axis 26 of the steering member 12.

The drive pulley 234 is connected with the ball nut assembly 20 by a drive belt 240. The drive belt 240 transmits force to the ball nut assembly 20 to rotate the ball nut assembly about the axis 26 of the steering member 12 during operation of at least the first motor 30. Therefore, the steering member 12 moves axially relative to the housing 14 to turn the steerable vehicle wheels upon actuation of the first motor 230.

The second electric motor 70 may move the steering member 12 axially relative to the housing 14 to turn the steerable vehicle wheels in the same manner that the motor 70 of the apparatus 10 of FIGS. 1-4 moves the steering member axially. The second reversible electric motor 70 (FIG. 5) is operable to rotate a pinion in meshing engagement with a rack portion of the steering member 12. Rotation of the pinion relative to the housing 14 is effective to move the steering member 12 axially relative to the housing 14. The second electric motor 70 may rotate a worm shaft in meshing engagement with a worm wheel connected with the pinion. The pinion may be press fit on the worm wheel. The worm wheel and pinion 72 rotate in response to rotation of the electric motor 70. Thus, the steering member 12 moves axially relative to the housing 14 to turn the steerable vehicle wheels upon actuation of the second motor 70.

An ECU 100 may control the first and second motors 230, 70 in a manner similar to the example shown in FIGS. 1-4. The ECU may effect operation of the first and second motors 230, 70 to axially move the steering member 12 relative to the housing 14 to steer the vehicle wheels. The ECU may operate the first motor 230, the second motor 70 or both motors depending on the force necessary to move the steering member 12 relative to the housing 14. Vehicle condition sensors 102, 104 may sense torque applied to a steering wheel and a rotational position of the steering wheel and generate signals indicative of the torque and position. The ECU may effect operation of the first and second motors 230, 70 as a function of the output of the vehicle condition sensors 102. 104.

The sensor that senses the rotational position of the sensor wheel connected to the pinion may be electrically connected to the ECU 100. The electrical signals from the sensor are sent to the ECU 100. The ECU 100 analyzes the output of the sensor to determine if the steering member 12 has axially moved the predetermined amount.

The apparatus 210 may also include motor sensors 120, 122 that detect whether the first and second motors 230, 70 are operating correctly. The ECU may analyze the output of the motor sensors 120, 122 to determine if the first and second motors 230, 70 are operating correctly. If the ECU determines that one of the first and second motors 230, 70 is not operating correctly, the ECU may adjust the operation of the other motor to compensate for the motor not operating correctly. Therefore, the first and second motors 230, 270 may provide redundancy for each other.

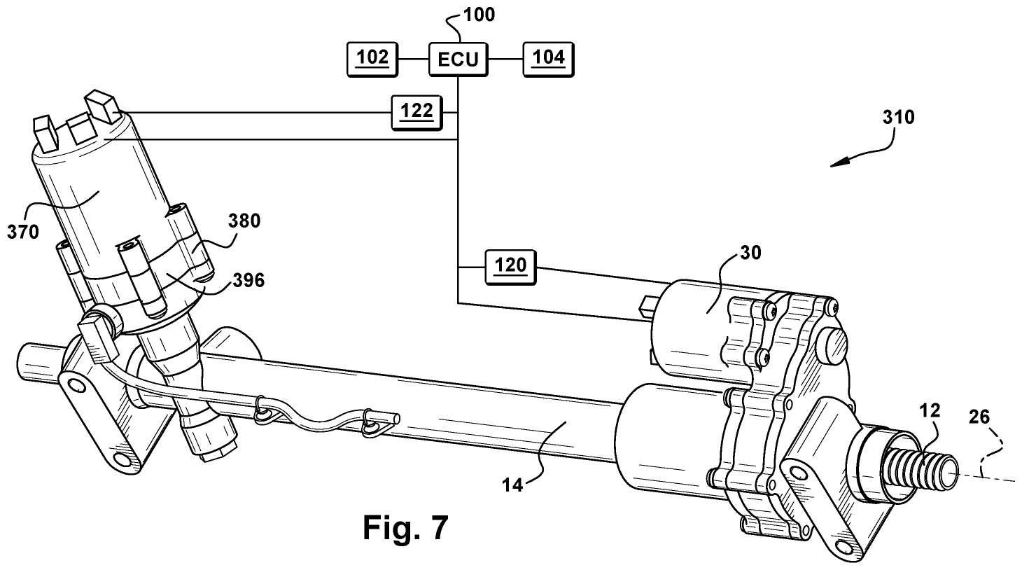

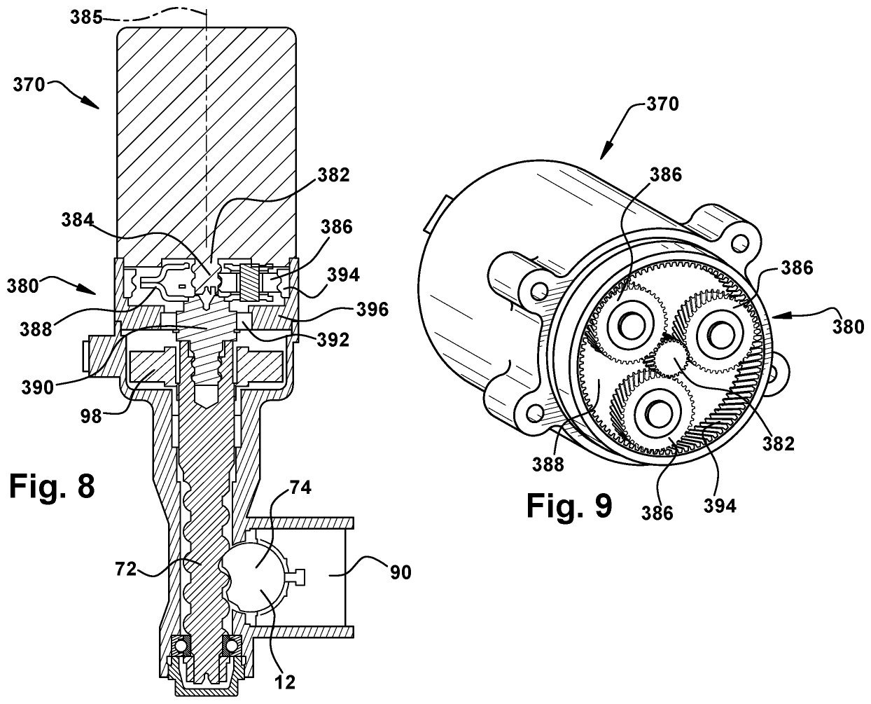

A third example of an apparatus 310 for turning steerable vehicle wheels constructed in accordance with the present invention is illustrated in FIGS. 7-9. The apparatus 310 of FIGS. 7-9 is generally similar to the apparatus 10 of FIGS. 1-4 and the apparatus 210 of FIGS. 5-6. Therefore, only the differences will be described in detail.

A first reversible electric motor 30 (FIG. 6) may move the steering member 12 axially relative to the housing 14 to turn the steerable vehicle wheels in the same manner that the motor 30 of the apparatus 10 of FIGS. 1-4 moves the steering member axially. The first electric motor 30 is operable to rotate the ball nut assembly relative to the steering member 12 and the housing 14. The first electric motor 30 has an output shaft with a helical drive gear. The helical drive gear and output shaft are supported in the housing 14 for rotation about a longitudinal axis extending generally parallel to the axis 26 of the steering member 12. The helical drive gear meshes with an idler gear to transmit torque from the first motor 30 to the idler gear. The idler gear is supported in the housing 14 for rotation about an axis extending generally parallel to the axis 26 of the steering member 12 and the axis of the helical drive gear.

The idler gear meshes with a driven gear on the ball nut assembly to transmit torque from the idler gear to the driven gear. The driven gear is fixedly connected to the ball nut assembly by a retaining member. The idler gear transmits force to the driven gear from the first motor 30 to rotate the ball nut assembly about the central axis 26 of the steering member 12 during operation of the first motor. Therefore, the steering member 12 moves axially relative to the housing 14 to turn the steerable vehicle wheels upon actuation of the first motor 30.

A second electric motor 370 (FIGS. 7-9) may move the steering member 12 axially relative to the housing 14 to turn the steerable vehicle wheels. The second reversible electric motor 370 is operable to rotate the pinion 72 in meshing engagement with the rack portion 74 of the steering member 12. Rotation of the pinion 72 relative to the housing 14 is effective to move the steering member 12 axially relative to the housing 14. The second electric motor 370 is operable to rotate the pinion 72 through a planetary gear stage 380.

The planetary gear stage 380 includes a sun gear 382 secured to an output shaft 384 of the second motor 370. The sun gear 382 rotates with the output shaft 384 about an axis 385. The sun gear 382 may be formed on the output shaft 384 or connected to the output shaft 384. Planetary gears 386 are in meshed engagement with the sun gear 382.

The planetary gears 386 are rotatably supported on a carrier 388. The carrier 388 has an output member 390 that extends into an opening in the pinion 72. The output member 390 may have a press fit connection with the pinion 72. Although the pinion 72 is described as having an opening into which the output member 390 of the carrier 388 extends, it is contemplated that the pinion may be press fit into an opening in the output member of the carrier. Also, it is contemplated that the carrier 388 may be connected to the pinion 72 in any desired manner.

The carrier 388 is supported by a bearing 392 for rotation relative to the output shaft 384 of the motor 370. The planetary gears 386 also mesh with teeth 394 on a housing 396 of the planetary gear stage 380. The housing 396 is fixed to the housing 14. The motor 370 rotates the sun gear 382 which causes the planetary gears 386 to rotate and orbit the sun gear while maintaining meshed engagement with the teeth 394. The carrier 388 rotates about the axis 385 as the planetary gears 386 rotate and orbit the sun gear 382. The output member 390 rotates with the carrier 388 to rotate the pinion 72. Thus, the steering member 12 moves axially relative to the housing 14 to turn the steerable vehicle wheels upon actuation of the second motor 370.

An ECU 100 may control the first and second motors 30, 370 in a manner similar to the example shown in FIGS. 1-4. The ECU may effect operation of the first and second motors 30, 370 to axially move the steering member 12 relative to the housing 14 to steer the vehicle wheels. The ECU may operate the first motor 30, the second motor 370 or both motors depending on the force necessary to move the steering member 12 relative to the housing 14. Vehicle condition sensors 102, 104 may sense torque applied to a steering wheel and a rotational position of the steering wheel and generate signals indicative of the torque and position. The ECU may effect operation of the first and second motors 30, 370 as a function of the output of the vehicle condition sensors 102, 104.

The sensor that senses the rotational position of the sensor wheel 98 connected to the pinion 72 may be electrically connected to the ECU 100. The electrical signals from the sensor are sent to the ECU 100. The ECU 100 analyzes the output of the sensor to determine if the steering member 12 has axially moved the predetermined amount.

The apparatus 310 may also include motor sensors 120, 122 that detect whether the first and second motors 30, 370 are operating correctly. The ECU may analyze the output of the motor sensors 120, 122 to determine if the first and second motors 30, 370 are operating correctly. If the ECU determines that one of the first and second motors 30, 370 is not operating correctly, the ECU may adjust the operation of the other motor to compensate for the motor not operating correctly. Therefore, the first and second motors 30, 370 may provide redundancy for each other.

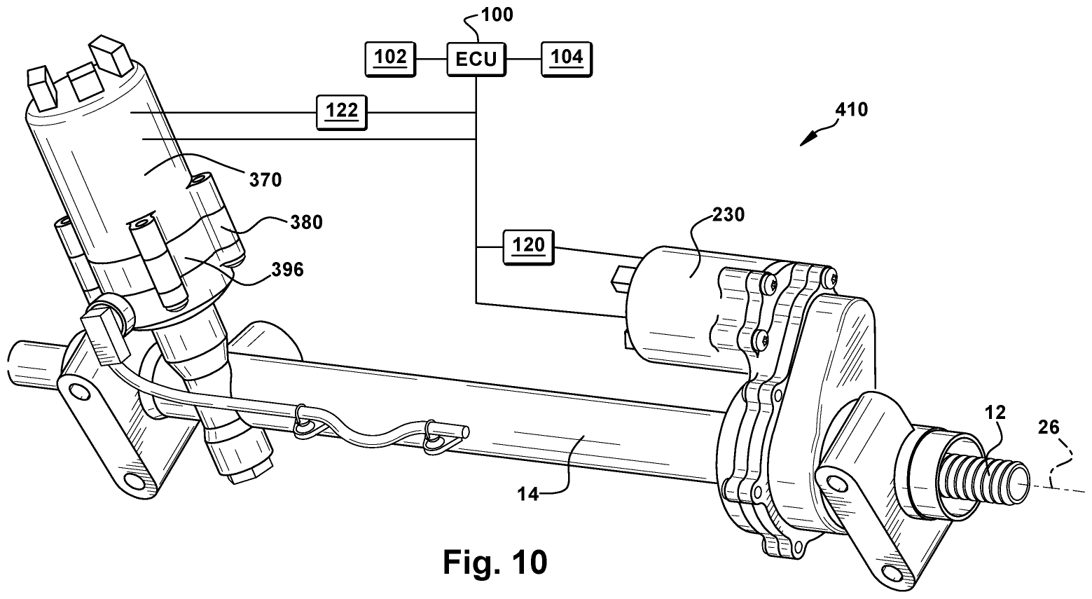

A fourth example of an apparatus 410 for turning steerable vehicle wheels constructed in accordance with the present invention is illustrated in FIG. 10. The apparatus 410 of FIG. 10 is generally similar to the apparatus 10 of FIGS. 1-4, the apparatus 210 of FIGS. 5-6 and the apparatus 310 of FIGS. 7-9. Therefore, only the differences will be described in detail.

A first reversible electric motor 230 (FIG. 10) may move the steering member 12 axially relative to the housing 14 to turn the steerable vehicle wheels in the same manner that the motor 230 of the apparatus 210, shown in FIGS. 5-6 moves the steering member axially. The first electric motor 230 has an output shaft connected to a drive pulley. The drive pulley and the output shaft are supported in the housing 14 for rotation about a longitudinal axis extending generally parallel to the axis 26 of the steering member 12.

The drive pulley is connected with the ball nut assembly 20 by a drive belt. The drive belt transmits force to the ball nut assembly 20 to rotate the ball nut assembly about the axis 26 of the steering member 12 during operation of at least the first motor 30. Thus, the steering member 12 moves axially relative to the housing 14 to turn the steerable vehicle wheels upon actuation of the first motor 230.

A second reversible electric motor 370 may move the steering member 12 axially relative to the housing 14 to turn the steerable vehicle wheels in the same manner that the motor 370 of the apparatus 310, shown in FIGS. 7-9 moves the steering member axially. The second reversible electric motor 370 is operable to rotate the pinion in meshing engagement with the rack portion of the steering member 12. Rotation of the pinion relative to the housing 14 is effective to move the steering member 12 axially relative to the housing 14. The second electric motor 370 is operable to rotate the pinion through a planetary gear stage 380.

The planetary gear stage 380 includes a sun gear secured to an output shaft of the second motor 370. The sun gear rotates with the output shaft about an axis. Planetary gears are in meshed engagement with the sun gear. The planetary gears are rotatably supported on a carrier. The carrier has an output member connected to the pinion. The carrier is supported by a bearing for rotation relative to the motor 370. The planetary gears also mesh with teeth on the planetary gear stage housing 396. The motor 370 rotates the sun gear which causes the planetary gears to rotate and orbit the sun gear while maintaining meshed engagement with the teeth on the housing. The carrier rotates about the axis as the planetary gears rotate and orbit the sun gear. The output shaft rotates with the carrier to rotate the pinion. Therefore, the steering member 12 moves axially relative to the housing 14 to turn the steerable vehicle wheels upon actuation of the second motor 370.

An ECU 100 may control the first and second motors 230, 370 in a manner similar to the example shown in FIGS. 1-4. The ECU may effect operation of the first and second motors 230, 370 to axially move the steering member 12 relative to the housing 14 to steer the vehicle wheels. The ECU may operate the first motor 230, the second motor 370 or both motors depending on the force necessary to move the steering member 12 relative to the housing 14. Vehicle condition sensors 102, 104 may sense torque applied to a steering wheel and a rotational position of the steering wheel and generate signals indicative of the torque and position. The ECU may effect operation of the first and second motors 230, 370 as a function of the output of the vehicle condition sensors 102, 104.

The sensor that senses the rotational position of the sensor wheel connected to the pinion may be electrically connected to the ECU 100. The electrical signals from the sensor are sent to the ECU 100. The ECU 100 analyzes the output of the sensor connected to the pinion to determine if the steering member 12 has axially moved the predetermined amount.

The apparatus 410 may also include motor sensors 120, 122 that detect whether the first and second motors 230, 370 are operating correctly. The ECU may analyze the output of the motor sensors 120, 122 to determine if the first and second motors 230, 370 are operating correctly. If the ECU determines that one of the first and second motors 230, 370 is not operating correctly, the ECU may adjust the operation of the other motor to compensate for the motor not operating correctly. Therefore, the first and second motors 230, 370 may provide redundancy for each other.

As can been seen from the above description, the apparatus of the present invention may be used in a steer-by-wire system that is free of a mechanical connection between a steering wheel and the steerable vehicle wheels. The apparatus of the present invention may be used to autonomously steer the vehicle wheels.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A steer-by wire apparatus for use in turning steerable vehicle wheels, the apparatus comprising:
a steering member which is axially movable relative to the vehicle to effect turning movement of the steerable vehicle wheels;
a ball nut assembly connected with an externally threaded portion of the steering member, the steering member moving axially in response to rotation of the ball nut assembly relative to the steering member;
a first motor connected with the ball nut assembly, the first motor being operable to effect rotation of the ball nut assembly relative to the steering member;
a pinion in meshing engagement with the steering member, the steering member moving axially in response to rotation of the pinion; and
a second motor connected with the pinion, the second motor being operable to effect rotation of the pinion relative to the steering member.

2. A steer-by wire apparatus as set forth in claim 1 further including a gear connected with the ball nut assembly and rotatable with the ball nut assembly relative to the steering member, the first motor being operable to effect rotation of the gear and the ball nut assembly relative to the steering member.

3. A steer-by wire apparatus as set forth in claim 2 further including an idler gear in meshing engagement with the gear connected with the ball nut assembly, the first motor being operable to effect rotation of the idler gear to effect rotation of the gear and the ball nut assembly relative to the steering member.

4. A steer-by wire apparatus as set forth in claim 1 further including a worm shaft connected to an output shaft of the second motor, the worm shaft being in meshing engagement with a worm wheel connected to the pinion.

5. A steer-by wire apparatus as set forth in claim 4 wherein the worm wheel has a press fit connection with the pinion.

6. A steer-by wire apparatus as set forth in claim 1 further including a drive pulley connected to an output shaft of the first motor and a belt connected to the drive pulley and the ball nut assembly, the first motor being operable to effect rotation of the drive pulley, the belt transmitting force from the drive pulley to ball nut assembly to rotate the ball nut assembly relative to the steering member.

7. A steer-by wire apparatus as set forth in claim 1 further including a planetary gear stage connecting the second motor to the pinion.

8. A steer-by wire apparatus as set forth in claim 7 wherein the planetary gear stage has a press fit connection with the pinion.

9. A steer-by wire apparatus as set forth in claim 7 wherein the planetary gear stage includes a sun gear rotatable with an output shaft of the second motor, at least one planetary gear being in meshing engagement with the sun gear and supported for rotation on a carrier connected to the pinion, the at least one planetary gear being in meshing engagement with teeth on a housing, the at least one planetary gear rotating and orbiting the sun gear during operation of the second motor, the carrier rotating relative to the output shaft of the second motor as the at least one planetary gear rotates and orbits the sun gear.

10. A steer-by wire apparatus as set forth in claim 9 wherein the carrier has an output member connected to the pinion, the output member having a press fit connection with the pinion.

11. A steer-by wire apparatus as set forth in claim 2 further including a worm shaft connected to an output shaft of the second motor, the worm shaft being in meshing engagement with a worm wheel connected to the pinion.

12. A steer-by wire apparatus as set forth in claim 2 further including a planetary gear stage connecting the second motor to the pinion.

13. A steer-by wire apparatus as set forth in claim 6 further including a worm shaft connected to an output shaft of the second motor, the worm shaft being in meshing engagement with a worm wheel connected to the pinion.

14. A steer-by wire apparatus as set forth in claim 6 further including a planetary gear stage connecting the second motor to the pinion.

15. An apparatus as set forth in claim 1 further including an electronic control unit (ECU) that controls the first and second motors and at least one motor sensor connected with the ECU that detects whether at least one of the first and second motors is operating correctly, the ECU adjusting operation of one of the first and second motors if the other of the first and second motors is not operating correctly.

16. An apparatus as set forth in claim 1 wherein the first and second motors provide redundancy for each other.
